(19) United States
(12) Patent Application Publication
(10) Pub. No.: US 2017/0195765 A1
(43) Pub. Date: Jul. 6, 2017

(54) WEARABLE DEVICE FOR CONVERSATION DURING HIGH MOTION ACTIVITY

(71) Applicants: Sebastian Koper, Toronto (CA); Bart Lipski, Toronto (CA)

(72) Inventors: Sebastian Koper, Toronto (CA); Bart Lipski, Toronto (CA)

(21) Appl. No.: 15/376,649

(22) Filed: Dec. 12, 2016

Related U.S. Application Data
(60) Provisional application No. 62/266,153, filed on Dec. 11, 2015.

(51) Int. Cl. H04R 1/10

(52) U.S. Cl. CPC H04R 1/105; H04R 1/1091; H04R 1/1016; H04R 2460/13; H04R 2201/107

(57) ABSTRACT

The exemplary embodiments herein provide a device for conversation between users during activity comprising a pair of arms which are substantially symmetrical about a central axis. Each arm preferably has a first portion which rests behind the head and below the occipital bone of the skull of a user, a second portion extending forwardly from the first portion and towards the ear of a user, a third portion which extends upwardly and away from the second portion, wrapping over the top of the ear of a user and also extending inwardly towards the central axis of the device, and a fourth portion which extends downwardly from the third portion and increases in cross-section area as it approaches a bottom cavity which contains a vibration exciter.

### CROSS-REFERENCE TO RELATED APPLICATIONS

This application claims priority to U.S. Provisional Application No. 62/266,153 filed on Dec. 11, 2015, which is herein incorporated by reference in its entirety.

### TECHNICAL FIELD

Embodiments generally relate to wearable devices which can communicate with each other along with other types of devices.

### BACKGROUND OF THE ART

During many activities, it is desirable for the participants to be able to effectively communicate with one another. For a number of reasons, including but not limited to the distance between the participants, surrounding background noise, and the human limitations of speaking/hearing, it is difficult for participants to communicate with each other in the standard way. Comfort and security of these types of devices can also be important as the participant may be engaged in the activity for several hours a day or more and may be making drastic movements that could cause the device to become dislodged from the participant and either damaged or lost.

### SUMMARY OF THE EXEMPLARY EMBODIMENTS

Exemplary embodiments provide a device for users to communicate with one another while performing high motion activities such as motorcycle riding, skiing/snowboarding, kiteboarding, wakeboarding, cycling, jet skiing, snowmobiling, cross country skiing, and other similar activities. In some cases the device may be used between two or more active participants in the activity and in other cases the device may be used by one person engaged in the activity (student) and another person (instructor) who could be moving or relatively stationary but is communicating with the first person to provide instruction. The device is also useful in professional situations like construction and rescue (fire fighters, coast guard, mountain rescue, etc.).

The exemplary embodiments would preferably have two arms which are symmetrical about a central axis, each arm having a temporal bone contact point along with an arm termination fitted with a vibration exciter, preferably located near the lateral pterygoid tissue of the user. The rear of the device may provide a housing for the electronic components and this housing may be designed to rest upon the user's neck, just below the skull.

It is an object of the exemplary embodiments of the invention to provide a means for improved voice communications among a group of users while performing sports, outdoor activities, and professional activities.

It is another objective to provide a means for improved voice communications that is waterproof and resistant to wind noise, which are often customary when participating in some sports and outdoor activities.

It is yet another object of the exemplary embodiments of the invention to provide an unobtrusive communications device which is easily worn on the back of the neck and side of the face, and uses components which leave the user's ears open to the ambient environment. This provides an elevated level of safety during operation.

It is an additional object of the exemplary embodiments of the invention to allow the user to operate the device without regular digital manipulation. This allows the users to maintain continual operation and control of the equipment used during the performance of sports, outdoor activities, and professional activities.

It is yet a further object of the exemplary embodiments of the invention to provide a means of voice communication which is not dependent on other external devices such as a mobile phone or on existing telecommunications infrastructure. This allows the users to operate the devices in remote areas and without the need to carry a mobile phone.

Various embodiments of the wearable, recreational communications device may use ear buds protruding from the housing or vibration exciters which are contained in a housing and are located near the temporal area of the head. The vibration exciters emit vibrations which are designed to be transmitted through nongaseous media such as the skin. When the device is worn as designed, the exciters located near the ear transmit transcutaneous vibrations which are then received by the inner ear of the user.

The foregoing and other features and advantages of the exemplary embodiments of the invention will be apparent from the following more detailed description of the particular embodiments, as illustrated in the accompanying drawings.

### BRIEF DESCRIPTION OF THE DRAWINGS

A better understanding of an exemplary embodiment will be obtained from a reading of the following detailed description and the accompanying drawings wherein identical reference characters refer to identical parts and in which:

FIG. 1 is a side elevation view of an exemplary embodiment of the device;

FIG. 2 is a rear elevation view of an exemplary embodiment of the device;

FIG. 3 is a side view of the device being worn by a user;

FIG. 4 is a rear view of the device showing the relationship between the temple to temple dimension of a user and the temple contact points on the device;

FIG. 5 is a perspective view of an exemplary embodiment of the device;

FIG. 6 is a top plan view of an exemplary embodiment of the device;

FIG. 7 is a rear perspective view of the device being worn by a user and underneath a helmet;

FIG. 8 is a rear elevation view of the device being worn by a user and underneath a helmet;

FIG. 9 is a top plan view of an exemplary embodiment for the internal electronic assembly;

FIG. 10 is a rear perspective illustration of an alternative embodiment of the device while being worn by a user; and

FIG. 11 is an electrical block diagram showing several components which may be contained within the rear housing (or first portion).

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/ or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

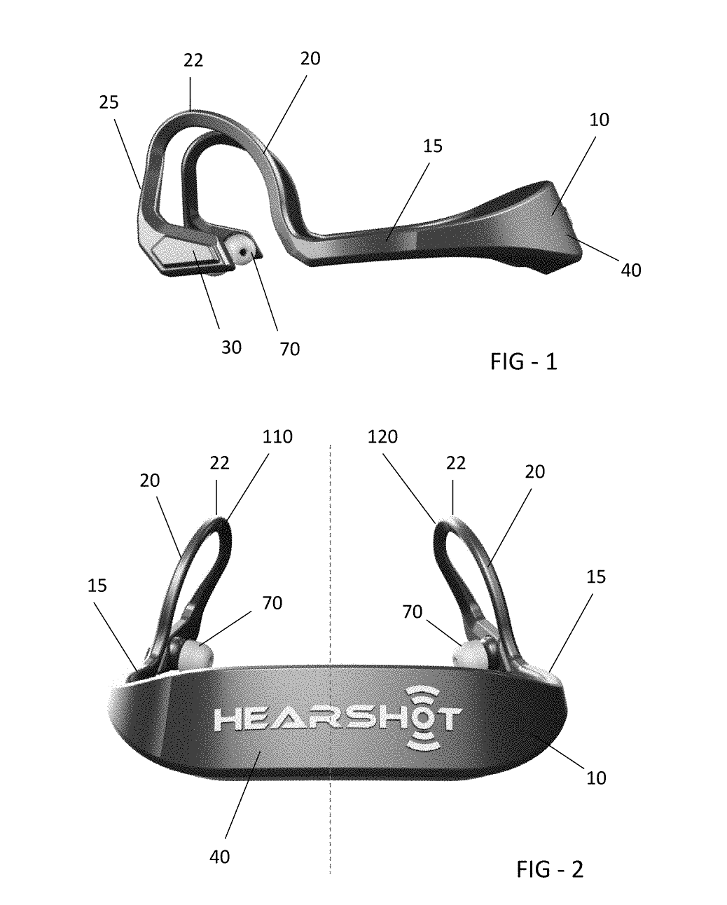

FIG. 1 is a side elevation view of an exemplary embodiment of the device. When positioned horizontally as in this figure, the device can be described as a continuous series of five different portions. Moving from the back to the front of the device, the first portion 10 is located in the rear and generally is large enough to store the internal electronic components 40 for operating the device inside. The second portion 15 extends forwardly from the first portion 10 and is generally parallel to (or existing in the same plane of) the first portion 10. As shown here, when the device is positioned horizontally, the first and second portions 10 and 15 are substantially horizontal. The average cross-sectional area of the second portion 15 is generally less than the average cross-sectional area of the first portion 10.

The third portion 20 extends forwardly from the second portion 15 and can be described as an arc that begins vertically (or substantially perpendicular to the second portion 15) and arcs around a substantially continuous radius until reaching the highest vertical point 22 of the device (which should be either resting on the top of the ear or resting just above the top of the ear). After passing the highest point 22, the third portion 20 continues to arc until becoming substantially vertical, which is when the fourth portion 25 begins. The fourth portion 25 is generally vertical and/or substantially perpendicular to the second portion 15. The third portion 20 and the fourth portion 25 have average cross-sectional areas that are substantially equal to each other, and may be substantially equal to the average cross-sectional area of the second portion 15, or can have an average cross-sectional area that is less than that of the second portion 15. The fourth portion 25 of this embodiment traverses substantially vertically along the front of the ear.

In this embodiment, the device includes a fifth portion 30 which extends rearwardly from the fourth portion 25, and is substantially perpendicular to the fourth portion 25. It should be expressly noted that some exemplary embodiments do not include a fifth portion 30, as shown and described below. When used, the fifth portion 30 is generally parallel to the first portion 10 and second portion 15 and would preferably lie within the same horizontal plane as the first portion 10 and second portion 15. The average cross-sectional area of the fifth portion 30 is generally larger than that of the fourth, third, and second portions 25, 20, and 15 respectively. In this embodiment, an ear bud 70 preferably extends from the fifth portion 30 and towards the symmetrical centerline of the device.

FIG. 2 is a rear elevation view of the embodiment of the device shown in FIG. 1. As shown, the device is generally symmetrical about a vertical centerline where each side of this embodiment of the device would contain a first 10, second 15, third 20, fourth 25, and optional fifth 30 portion (where the first portion 10 is generally split along the centerline, such that each side of the device provides one half of the total first portion 10). As the third portion 20 travels vertically from the second portion 15 and begins the arc, it can be observed that the third portion 20 also moves inwardly, towards the vertical centerline of the device. In other words, the third portion 20 extends from the second portion 15 in a direction towards the temple of a user. The furthest point inward toward the vertical centerline can be referred to as the temple contact points 110/120 and these can occur at or near the highest vertical points 22, but this is not required. Generally, the temple contact points 110/120 should be somewhere on the third portion 20.

The temple contact points 110/120 should rest against and/or press against the temporal bone of the skull, generally referred to as the temple area on the side of a user's head. Depending on the size of the device relative to the user, in some embodiments the temple contact points 110/120 may rest against and/or press against the bottom portion of the parietal bone of the skull as well. As shown in FIG. 2, the first portion 10 should be wider than the distance between the temple contact points 110/120. The horizontal distance between the temple contact points 110/120 should preferably be less than the horizontal distance between the ear buds 70.

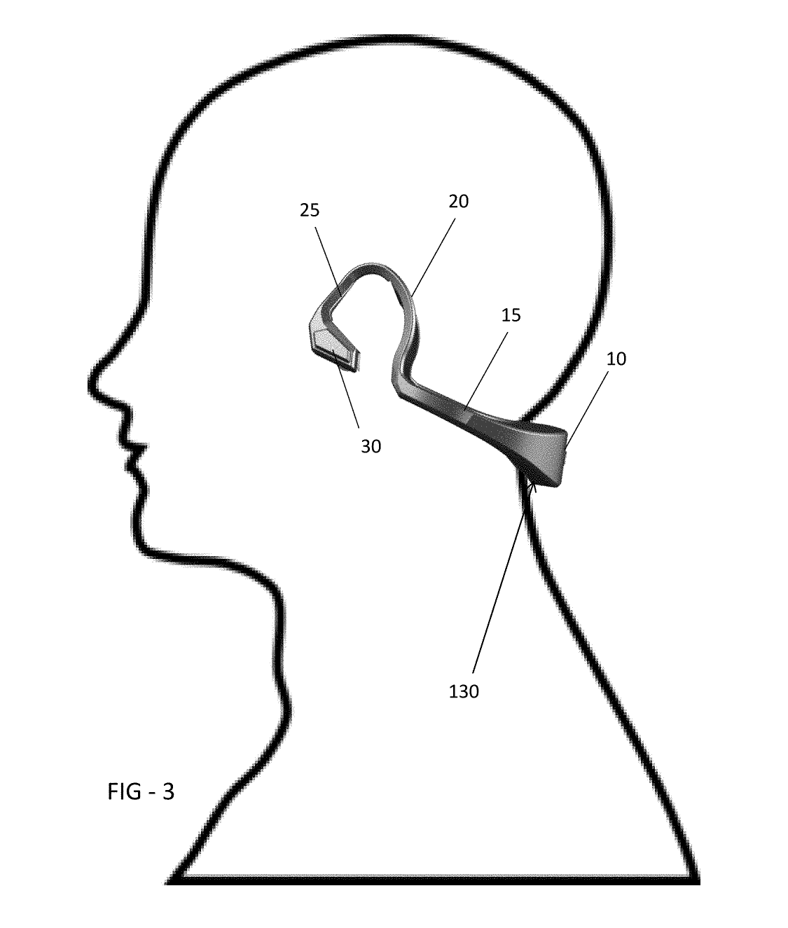

FIG. 3 is a side view of the embodiment of the device shown in FIG. 1 while being worn by a user. As shown, when the device is in use, the second portion 15 is no longer substantially horizontal, but slopes downwardly as it travels around the back of the user's head. The bottom area of the first portion 10 is referred to as the neck contact point 130 and may be the bottom surface and/or inside surface of the first portion 10, depending on the size of the user relative to the size of the device. During use, the neck contact point 130 should rest below the occipital bone of the skull and preferably upon the user's upper trapezius muscle, generally above the semispinalis capitis muscle. Preferably, the neck contact point 130 sits below the external occipital crest of the skull.

It is preferable that the fifth portion 30 of the device is positioned to partially cover the external ear canal when the device is in use. Preferably, the fifth portion 30 of the device has a surface area that is 35%-75% of the size of the surface area of the external ear canal (measured at the intersection with the pinna) and it should be aligned with the external ear canal. In this way, surrounding noise (specifically wind noise) can be shielded from interfering with the sound from the ear buds 70.

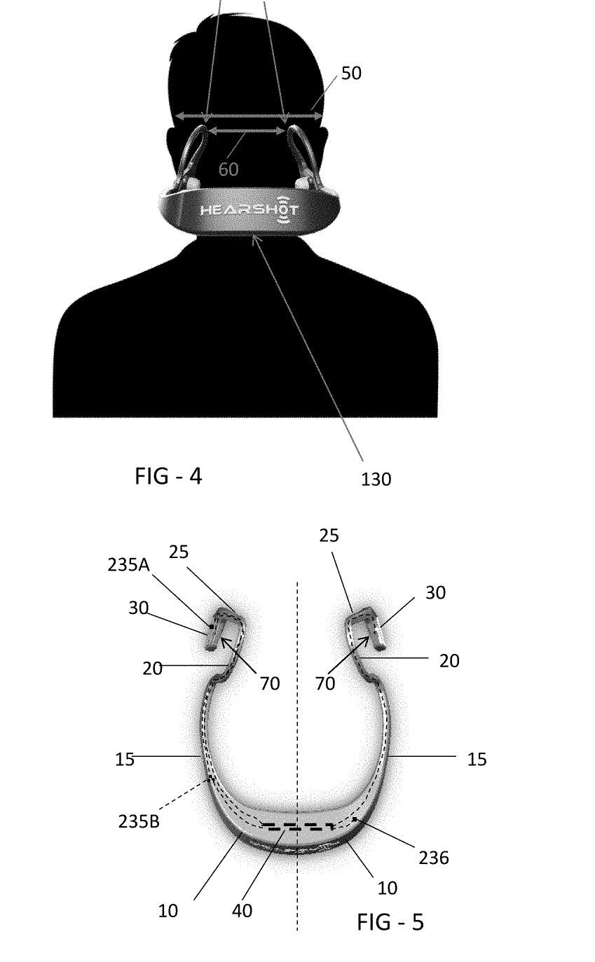

FIG. 4 is a rear view of the embodiment of the device shown in FIG. 1, showing the relationship between the temple to temple dimension of a user and the temple contact points 110/120 on the device. The device is not in use here (worn by the user) but instead is placed behind the user's head so as to illustrate the difference between the temple to temple distance 50 of the user with the temple contact point distance 60 when the device is at rest (not in use or being worn). As shown, it is preferable that the temple contact point distance 60 is less than the temple to temple distance 50 of the user, so that when worn by the user the device will create a slight pressure against the temples of the user (or at the skull contact points described above). An exemplary embodiment of this version of the device would contact the user primarily at five points: temple contact point 110, temple contact point 120, left ear bud 70, right ear bud 70, and neck contact point 130. Due to the weight of the electronic components 40, the device creates a moment about the center of gravity of the device to put most of the weight of the device at the neck contact point 130 and away from the more sensitive ear canals and temples. In this way, the device wants to rotate in a clock-wise direction (when viewing FIG. 3) to create this pressure at the neck contact point 130. This is accomplished primarily by the geometry shown and described above.

FIG. 5 is a top plan view of the embodiment of the device shown in FIG. 1. When oriented horizontally and viewed from the top, the device is generally symmetrical about a horizontal centerline. In other words, the device contains a pair of arms where each arm has a first portion 10, second portion 15, third portion 20, fourth portion 25, and fifth portion 30. Generally, the two arms are mirror images of each other and would be considered symmetrical about the horizontal center axis.

The electronic components 40 are preferably placed within the first portion 10 (which generally spans across at least a portion of both arms) which could also be referred to as the rear housing. The ear buds 70 may be electrically connected to the PCB 250 at the speaker portion 240 (illustrated further below) and preferably the electrical connections travel through each portion of each arm before reaching the fifth portion 30 and the ear buds 70.

A microphone 235A is preferably placed on one side of the device, and preferably near the fifth portion 30 or ear bud 70. Alternatively, the microphone 235B could be positioned closer to the rear of the device, preferably on the second portion 15. The microphone 235 is preferably electrically connected to the PCB 250 and again the electrical connections travel through each portion of the arm before reaching the microphone 235. In some embodiments, an optional second microphone 236 may be used and is preferably placed on the opposite side of the device as the first microphone 235. Preferably, the first microphone 235 is placed near the front of the device while the second microphone 236 is placed near the rear of the device. In an exemplary embodiment, the second microphone 236 would be placed either on the first portion 10 (i.e. near the rear housing), near the intersection of the first portion 10 and second portion 15, or at the rear of the second portion 15. The second microphone 236 can assist with a noise cancellation algorithm, which will be described further below.

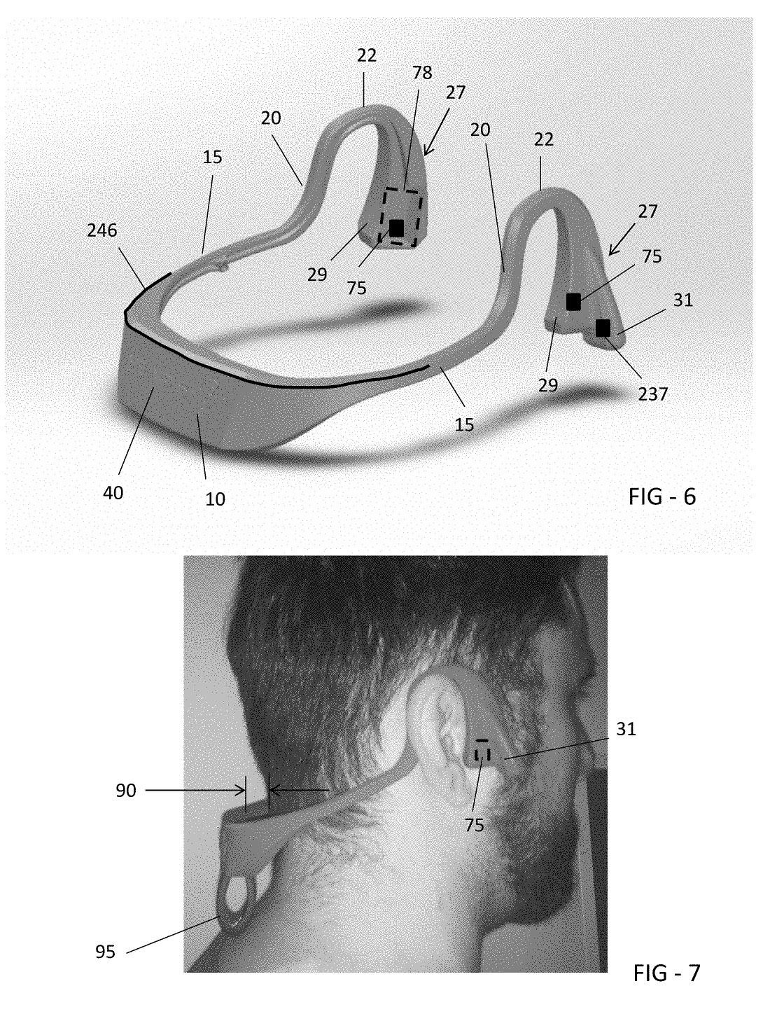

FIG. 6 is a perspective view of an exemplary embodiment of the device. In this exemplary embodiment, many of the features described above with reference to the embodiment of FIG. 1 are the same. However, there are a couple notable differences. First, the fifth portion 30 is not used and a different type of fourth portion is used instead. In this embodiment, the fourth portion 27 begins near the highest vertical point 22 of the third portion 20 and begins with a small cross-sectional area (substantially the same cross-sectional area as the third portion 20) that gradually increases as the fourth portion 27 moves downwardly in a substantially vertical manner. One of the arms preferably ends with an elongate protrusion 31 in the housing to accommodate a microphone 237. As shown above, various embodiments of the device could also use multiple microphones placed in various areas of the device. Specifically, the additional microphone 236 placed near the first portion 10 of the device could be used for noise cancellation. As noted herein, any of these combinations could be used with the embodiment shown in FIGS. 6-7.

The antenna 246 for this embodiment is preferably routed inside of the housing, and near the top inside corner which is furthest away from the user's head. The antenna 246 should cover the entire first portion 10 and extend almost to the mid-point of the second portion 15. Generally speaking, the antenna 246 is typically a single antenna but could include a second antenna also in the first portion 10 as well for diversity combining. As noted herein, the antenna 246 is in electrical connection with the electronics 40. All wiring for the antenna 246, exciters 75, and microphone(s) 237 is again routed through the arms of the device, similar to the embodiment shown in FIG. 5.

An area near the bottom of the fourth portion 27 of this embodiment preferably has the largest cross-sectional area and provides a cavity 29 for accepting a vibration exciter 75 which is preferably sealed within the cavity 29 by a membrane 78 that would substantially prevent water, dirt, and dust from entering the cavity 29 and contacting the vibration exciter 75. As shown, this embodiment is again generally symmetrical about a central axis and contains a vibration exciter 75 on both sides. However, it should be noted that this is an exemplary embodiment, and other embodiments could utilize only a single exciter 75 on a single side only.

FIG. 7 is a side view of the embodiment shown in FIG. 6 while being worn by a user. Here, the optional base element 95 is positioned on the bottom side of the rear housing of the first portion 10. The base element 95 is preferably a rubber or elastomeric strap, but it could also be a strap of various other materials, including but not limited to woven fabric straps or straps which are a combination of different compressible materials. Generally, when using a strap as the base element 95, the strap contains a pair of opposing ends, which are each fastened to the first portion 10, preferably close to one another. In other embodiments, the base element 95 may be a foam or soft plastic. Generally, the base element 95 should be compressible and not rigid, but this is not required. The base element 95 should rest atop upon the user's upper trapezius muscle, generally above the semispinalis capitis muscle and should create the gap 90 between the back of the neck of the user and the inside surface of the first portion 10 (or the rear housing). The base element 95 should provide additional security for the placement of the device on the head and additional comfort for the user. It should be positioned to isolate low-frequency vibrations that would be transmitted from the user's body to the device, and also to isolate high frequency vibrations that would be transmitted from the device to the back of the user's head.

In the exemplary embodiment shown in FIGS. 6-7, the fourth portion 27 extends downwardly from the third portion 20 and does not contain any rearwardly facing feature. The fourth portion 27 is a terminal compartment 29 which contains the vibration exciters 75 in both ends of the arms. Each compartment 29 is preferably sealed with a thin intermediary membrane 78. This membrane 78 has the function of sealing the compartment and preventing ingress of water, dust, and other foreign materials, reducing discomfort from the slight pressure applied at the area of contact of the skin, and enhancing the transmission of sound vibrations emitted from the vibration exciter 75. The membrane 78 will preferably have an acoustic impedance that will be similar to the acoustic impedance of transcutaneous tissue (approximately between 1.4×10⁶ and 1.8×10⁶ kg/(m²s)), thereby minimizing reflection and transmission loss of the sound vibrations and improving overall sound quality. The membrane 78 should preferably contact the temporal bone, resting atop the lateral pterygoid tissue of the user.

The membrane 78 may be manufactured from rubber, plastic, foam, or a material containing a gel. In this exemplary embodiment of the invention, the microphone 237 is located only on one side (here the right side) of the device. The microphone 237 is contained in an elongate protrusion 31 from the terminal compartment 29 at the fourth portion 27. The elongate protrusion 31 is approximately 1″ in length but protrudes only about 0.25″ beyond the terminal compartment 29 in the vertical axis. The bottom of the elongate protrusion 31 is preferably angled approximately 15 degrees from the vertical axis of the device, towards the forward direction. When the device is worn on the user, the bottom of the elongate protrusion 31 is positioned approximately 30 degrees from the vertical axis of the user's head, towards the forward direction. This position of the elongate protrusion 31 allows the device to optimize the ability of the microphone 237 to receive sound waves from the user's voice, and to reduce receiving sound waves from extraneous and undesired sources.

Note the location of the vibration exciter 75 relative to the ear of the user. In the exemplary embodiments with vibration exciters 75, the inward direction at third portion 20 results in a pressure force of 1-5N being applied at the point of contact between the vibration exciter 75 and the skin (with the membrane 78 in between). This force has been discovered to be optimal for ensuring sound vibrations emitted from the vibration exciters 75 are effectively transmitted into the transcutaneous tissue.

The antenna 246 preferably has a length between 16 and 34 cm. It should operate at ISM frequencies. The antenna 246 may be be embedded into the plastic enclosure using MID (molded interconnect device), LDS (laser direct structuring), or equivalent at the top edge of the housing in the first portion 10 and extending to the second portion 15 as shown. It has been discovered, that this orientation and construction of the antenna 246 provides several benefits.

First, it allows for a half or ⅝ or full wavelength antenna wire so that it maximizes antenna gain and efficiency. This delivers optimal performance for the device by maximizing the range the communications may be transmitted and received between devices. Second, the antenna 246 is also positioned along the arc edge of the housing so that it circumnavigates about 180 degrees around the head of the user. With the antenna 246 designed in this way, it is able to establish a radiation pattern radially out into the horizontal and vertical planes. There is no or minimal intended antenna directivity towards any part of the human body. This design optimizes antenna efficiency and performance by directing it outwards rather that into the body of the user. Furthermore, because it circumnavigates the head in such a way, the antenna 246 better ensures that the device is better able to receive/transmit communications signals from/to other devices in the designated group. Third, the routing of the antenna 246 along the arc edge obviates protruding antenna poles oriented vertically out of the housing of the device. This minimizes physical interference, discomfort to the user, and possible risk of damage to the antenna 246.

As shown in the exemplary embodiments of FIGS. 6 and 7, the device generally does not cover the ear of a user. The vibration exciters 75 are positioned to transmit vibrations to an area of tissue in front of the ear (lateral pterygoid tissue). In this way, a user is still able to hear anything in the ambient environment that might be important and also prevents injury to the interior of the ear when the user goes through any type of shock or crash.

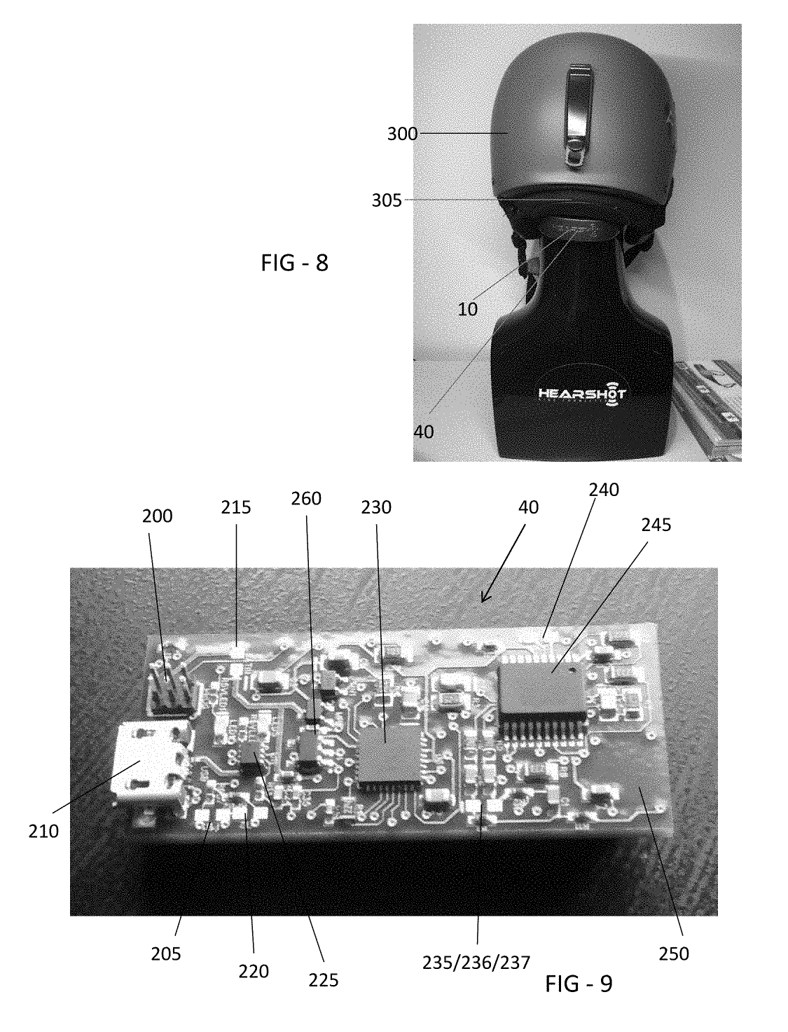

FIG. 8 is a rear elevation view of the device being worn by a user and underneath a helmet 300. As shown, when placed underneath a helmet, the second 15, third 20, fourth 25/27, and fifth 30 (if used) should be underneath the helmet (either the shell or under the earflaps of the helmet) while the first portion 10 remains outside of the helmet 300, directly underneath the bottom edge 305 of the helmet.

FIG. 9 is a top plan view of an exemplary embodiment for the internal electronic components 40. Here, a PCB 250 contains a number of electronic components for operating the device. These components include but are not limited to: a USB charge connector 210, push buttons 205, battery (connection) 215, power regulator 260, microprocessor+ISM transceiver radio 230, microphone 235, speaker (connection) 240, and audio codec 245.

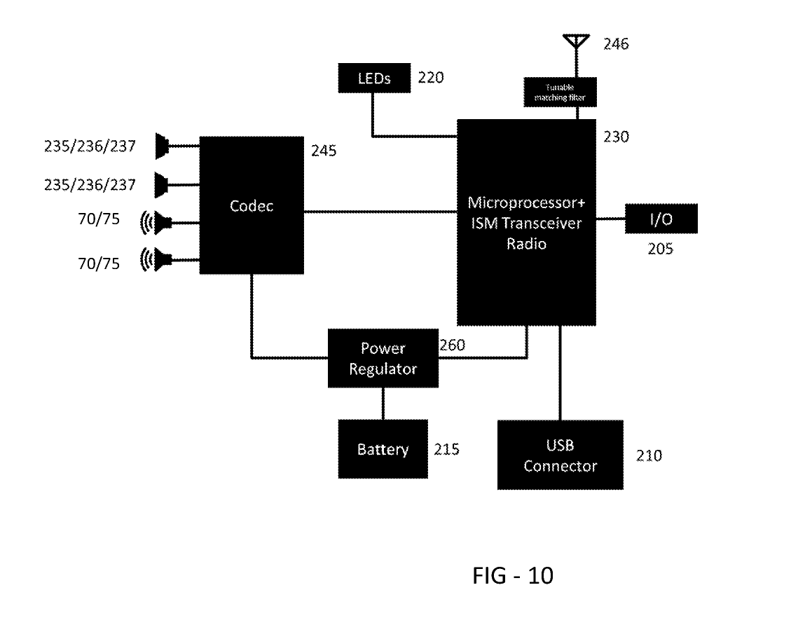

FIG. 10 is an electrical block diagram showing several components which may be contained within the rear housing (or first portion 10). These components include but are not limited to an audio codec 245, USB connector 210, output LEDs 220, power regulator 260, battery 215, antenna 246, microprocessor +ISM transceiver radio 230, microphone 235/236/237, and earbud speaker 70 (or vibration exciter 75). As noted above, in some embodiments a second microphone 236 may be used in order to perform a noise cancellation algorithm. In this embodiment, voice frequencies along with some ambient noise will be captured by the first microphone 235 while the second microphone 236 captures mostly ambient noise but with some voice frequencies as well. The two input waves are then shifted by 180 degrees in phase in order to create destructive interference. This preferably causes the ambient noise to be subtracted from the voice and ambient noise signal of the first microphone 235.

It should be noted that an exemplary embodiment may also use a pair of antennas 246 so that the device can utilize diversity combining with other devices. In this embodiment, the antennas 246 would preferably be separated so that one antenna is one a first arm of the device while a second antenna is on a second arm of the device.

The housing which makes up the first, second, third, fourth, and optional fifth portions is preferably constructed from a study plastic such as ABS or polycarbonate. An exemplary version of the housing is comprised of the rear body containing the battery and electronics, the arms which extend forward and around the side of the head, and the ends which contain the vibration exciters. The wires are routed throughout the housing to connect the various components. As shown, the housing may be designed with various cross-sectional thicknesses to allow the housing to bend to accommodate the various shapes and sizes of the users' heads but also to apply pressure to provide secure placement of the device on the head. Furthermore, the third portion 20 and fourth portion 25/27 of the housing may also contain various sections which are overmolded with an elastomer or rubber. This coating provides a comfortable texture but also increases the frictional force between the housing and the head, further ensuring secure placement of the device on the head.

The communications device employs a dynamic, dedicated, low-power communications network. The communications network operates on a broadcast, one-to-many system. For a group of users who wish to use the device, one person, self-designated temporarily as the ‘Master’, initiates a pairing process by pressing and holding down a pairing button (push button 205) located at the first portion 10 of the device. All other users nearby to the Master are able to be included in the communications group by also engaging in the pairing process. This process forms a designated group. During the pairing process, each device is assigned an identifier address and a group address. When a user begins speaking, the device detects the voice signal and prepares the device for transmission. The device is generally designed for transmitting voice communications. Typically, these voice communications frequencies are between 85 Hz and 255 Hz. An exemplary embodiment of the device would not transmit frequencies which are substantially outside of this voice frequency range, or which may otherwise be identified as being non-voice communications, including but not limited to wind, equipment, equipment interacting with the environment, urban and traffic noise, and general undesired sound.

Each device is preferably capable of transmitting the voice communication of its user and receiving voice communication from one other user in the designated group who is transmitting voice communication simultaneously. During operation, a user may be able to temporarily suspend receiving or transmitting any communications from any other device in the designated group. This may be required during an emergency when the user requires an increased level of situational awareness. Also, during operation, a user may opt to mute so that they are prevented from transmitting voice communications to other users in the designated group. When in a designated group, any user at any time is able to remove oneself by initiating an unpairing process.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

We claim:

1. A device for conversation between users during activity comprising:
a pair of arms which are substantially symmetrical about a central axis, each arm comprising
a first portion which rests behind the head and below the occipital bone of the skull of a user,
a second portion extending forwardly from the first portion and towards the ear of a user,
a third portion which extends upwardly and away from the second portion, wrapping over the top of the ear of a user and also extending inwardly towards the central axis of the device, and
a fourth portion which extends downwardly from the third portion and increases in cross-section area as it approaches a bottom cavity which contains a vibration exciter.

2. The device of claim 1 wherein:
the third portion contacts the skin atop the temporal bone of a user

3. The device of claim 1 further comprising:
electronics for driving the vibration exciters placed within the first portions of the two arms.

4. The device of claim 1 further comprising:
a membrane positioned between the vibration exciters and the skin of a user.

5. The device of claim 1 further comprising:
a base element positioned underneath the first portions of the two arms and between the device and the skin of the user.

6. The device of claim 1 further comprising:
a strap having a pair of ends where the first end and second end are attached to the first portions of the arms.

7. The device of claim 5 further comprising:
a gap between the back of the user's head and the first portion of the arms, where the width of said gap is defined by the base element.

8. The device of claim 1 further comprising:
a microphone placed within the fourth portion of one of the arms and near the vibration exciter.

9. A device for conversation between users during activity comprising:
a first portion which provides a rear housing and rests atop a base element which rests atop the trapezius muscle of a user,
a pair of elongate arms which are generally symmetrical about a central axis and extend forwardly from the rear housing, each arm comprising
a second portion extending forwardly from the first portion and towards the ear of a user,
a third portion which extends upwardly and away from the second portion, wrapping over the top of the ear of a user and also extending inwardly to contact the temporal bone of a user, and
a fourth portion which extends downwardly from the third portion and increases in cross-section area as it approaches a bottom cavity;
a vibration exciter within the bottom cavity of the fourth portion of each arm;
a microphone placed within the fourth portion of one of the arms; and
a printed circuit board placed within the rear housing and in electrical connection with the microphone and vibration exciters where the electrical connections are routed through the arms.

10. The device of claim 9 further comprising:
an antenna running along an entire length rear housing and continuing into the second portions of each arm.

11. The device of claim 10 wherein:
the antenna circumnavigates approximately 180 degrees around the head of the user.

12. The device of claim 10 wherein:
the antenna is positioned within the uppermost rearmost edge of the rear housing.

13. The device of claim 9 further comprising:
A membrane which covers the vibration exciter within each arm.

14. The device of claim 13 wherein:
the membrane has an acoustic impedance between approximately 1.4×10⁶ and 1.8×10⁶ kg/(m²s).

15. The device of claim 9 further comprising:
a strap which contacts the trapezius muscle of a user and is attached to the rear housing.

16. The device of claim 9 wherein:
a bottom of the microphone is angled away from vertical and towards the front of the device.

17. A device for conversation between users during activity comprising:
a pair of arms which are substantially symmetrical about a central axis, each arm comprising
a first portion which rests behind the head and below the occipital bone of the skull of a user,
a second portion extending forwardly from the first portion and towards the ear of a user,
a third portion which extends upwardly and away from the second portion, wrapping over the top of the ear of a user and contacting the temporal bone area of the user's head, and
a fourth portion which extends downwardly from the third portion and in front of the ear, without covering the ear;
a vibration exciter within the bottom cavity of the fourth portion of each arm;
a microphone placed within one of the arms;
an antenna positioned within an uppermost rearmost edge of the first portion of each arm, extending into the second portions of each arm; and
a printed circuit board placed within the rear housing and in electrical connection with the antenna, microphone, and vibration exciters where the electrical connections for the microphone and vibration exciters are routed through the arms.

18. The device of claim 17 further comprising:
a compressible base element positioned underneath the first portions of the two arms and between the device and the trapezius muscle of the user.

19. The device of claim 17 further comprising:
a membrane positioned between the vibration exciters and the lateral pterygoid tissue of the user.
